(19) United States
(12) Patent Application Publication
(10) Pub. No.: US 2026/0314520 A1
(43) Pub. Date: Oct. 15, 2026

(54) Agricultural Harvester

(71) Applicant: CLAAS Saulgau GmbH, 88348 Bad Saulgau (DE)

(72) Inventors: Stefan Birkhofer, Stockach (DE); Stefan Sauter, Zwiefalten (DE)

(21) Appl. No.: 19/314,105

(22) Filed: Aug. 29, 2025

(30) Foreign Application Priority Data
Sep. 10, 2024 (DE) 102024126012.2

(51) Int. Cl. A01B 73/02

(52) U.S. Cl. CPC A01B 73/02

(57) ABSTRACT

Agricultural harvester (10), with a frame or a framework (11) on which a chassis (15) of the harvester engages, with main booms (17), wherein on both sides of the frame or framework (11) a main boom (17) engages on the frame or framework (11) in such a way that, in order to transfer the harvester (10) between a working position and a transport position, the respective main boom (17) is movable relative to the frame or framework (11), with relief booms (20, 21), wherein two relief booms (20, 21) in each case engage on each of the two main booms (17), which relief booms are individually movable relative to the respective main boom (17) via relief cylinders (22, 23) in order to provide a relief function, and with working units (24), wherein in each case at least one working unit (24) engages on each of the relief booms (20, 21) and is movable relative to the respective relief boom (20, 21) in order to provide a ground-following function. FIG. 1

The invention relates to an agricultural harvester.

Agricultural harvesters that can be coupled to a towing vehicle in order to be moved by being pulled by the towing vehicle are known in practice. Such agricultural harvesters, moved by being pulled by a towing vehicle, include in particular forage harvesters, for example windrowers or tedders.

Agricultural harvesters known in practice have a frame or a framework, wherein on the one hand a chassis and on the other hand a drawbar engage on the frame or framework. During its movement, the agricultural harvester is supported on a ground surface via the chassis. The agricultural harvester can be coupled to a towing vehicle via the drawbar, namely via a coupling bracket engaging on the drawbar. In agricultural harvesters known in practice, booms with working units attached to them engage on the frame or framework.

As the working width of an agricultural harvester increases, the number of working units increases. With large working widths, in particular of more than 10 meters, it has hitherto been difficult to provide the working units with a relief function and a ground-following function in a targeted manner.

Proceeding from this, the object of the present invention is to make available an agricultural harvester which, even in the case of a large working width, provides a targeted relief function and ground-following function for the working units.

This object is achieved by an agricultural harvester according to Claim 1.

The agricultural harvester according to the invention has a frame or a framework on which a chassis engages.

The agricultural harvester according to the invention also has main booms, wherein on both sides of the frame or framework a main boom engages on the frame or framework in such a way that, in order to transfer the harvester between a working position and a transport position, the respective main boom is movable relative to the frame or framework.

The agricultural harvester according to the invention also has relief booms, wherein two relief booms in each case engage on each of the two main booms, which relief booms are individually movable relative to the respective main boom via relief cylinders in order to provide a relief function.

The agricultural harvester according to the invention also has working units, wherein in each case at least one working unit engages on each of the relief booms and is movable relative to the respective relief boom in order to provide a ground-following function.

The agricultural harvester according to the invention comprises the two main booms, wherein one of the two main booms engages the frame or framework on both sides of the frame or framework. Two relief booms engage on each of the two main booms. Each of the relief booms is movable relative to the respective main boom in order to provide a relief function, individual to each relief boom, for the working units engaging on the respective relief boom. Furthermore, each working unit of the agricultural harvester according to the invention is movable relative to the respective relief boom in order to provide an individual ground relief function. Thus, even with large working widths of the agricultural harvester according to the invention, a relief function and ground-following function can be provided for each working unit in a targeted manner.

Preferably, the respective main boom is designed as a telescopic boom with a first telescopic boom part engaging on the frame or framework and with a second telescopic boom part which can be telescoped relative to the first telescopic boom part, wherein preferably two relief booms engage on the respective second telescopic boom part, and wherein, in order to provide the relief function individually for each of the two respective relief booms, a relief cylinder engages with a first portion and each of the relief cylinders with a second portion on the respective second telescopic boom part. This is preferred in order to provide large working widths in the working position and to reduce the dimensions of the agricultural harvester in the transport position. In addition, a telescopic boom allows the forming or depositing of different windrows, such as middle windrows, side windrows or the formation of double windrows.

Preferably, a first of the two respective relief booms is a relief boom lying inward relative to a longitudinal central axis of the frame or framework in the working position, and a second of the two respective relief booms is a relief boom lying outward relative to the longitudinal central axis of the frame or framework in the working position, wherein the inward relief boom is movable, in particular pivotable, about an axle lying externally on same, and the outward relief boom is movable, in particular pivotable, about an axle lying internally on same, relative to the respective main boom via the respective relief cylinder. The working unit engaging on the inward relief boom is movable or swingable, in particular pivotable, relative to the inward relief boom about an axle lying preferably centrally on the inward relief boom, and the working unit engaging on the outward relief boom is movable or swingable, in particular pivotable, relative to the outward relief boom about an axle lying preferably centrally on the outward relief boom. This is particularly preferred in order to provide the relief function and ground-following function in a targeted manner for the respective relief boom and thus for the working unit acting on the respective relief boom.

Preferably, a relief cylinder engaging on the first respective relief boom is designed as a pressing cylinder, and a relief cylinder acting on the second respective relief boom is designed as a pulling cylinder. This is particularly preferred for providing the relief function and allows the relief cylinders and other required components to be accommodated in an advantageously space-saving manner within the booms, which are designed as hollow profiles.

Preferably, the two respective relief booms are coupled in order to limit the mobility of the two respective relief booms relative to each other in the working position of the harvester. Preferably, the working units engaging on the two respective relief booms are also coupled in order to limit the mobility of the two respective working units relative to each other in the working position of the harvester. By limiting the mobility of the two respective relief booms relative to each other and by limiting the relative mobility of the working units engaging on the two respective relief booms, a correct operation of the agricultural harvester, especially when transporting crops, can be provided in the working position when making available the relief function and ground-following function.

The pivot angle of the individual working units relative to the respective relief boom can additionally be limited by mechanical stops.

However, in the main work region, the working units can adapt to the ground independently of one another.

Preferably, the agricultural harvester is a forage harvester, in particular a merger or pickup belt rake, wherein a pickup for gathering crops from the ground and a belt conveyor segment for conveying the crops engage, as working units, on each of the relief booms. The invention is preferably used in a pickup belt rake, which is also referred to as a merger.

Preferred developments of the invention can be gathered from the dependent claims and from the following description. Exemplary embodiments of the invention are explained in more detail on the basis of the drawing, without being limited thereto. In the drawing:

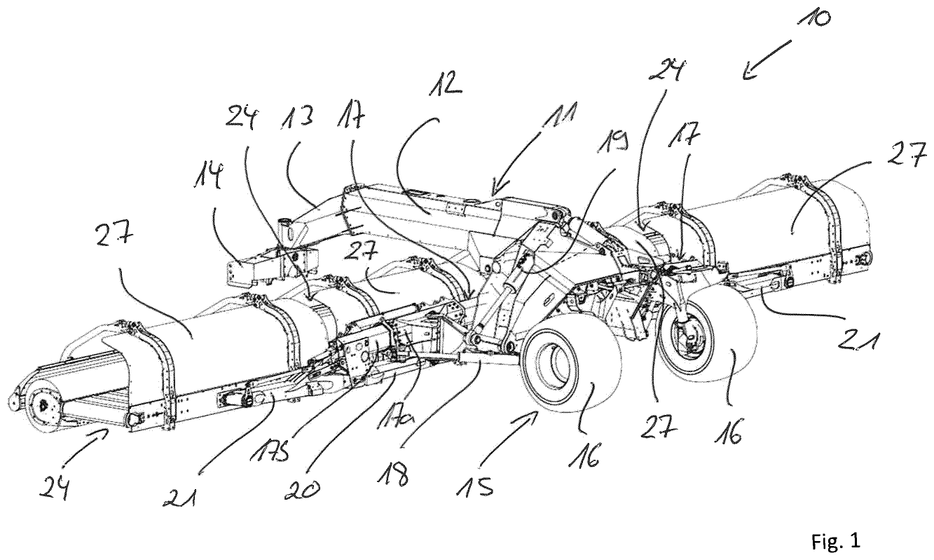

FIG. 1 shows a perspective view of an agricultural harvester according to the invention, from behind;

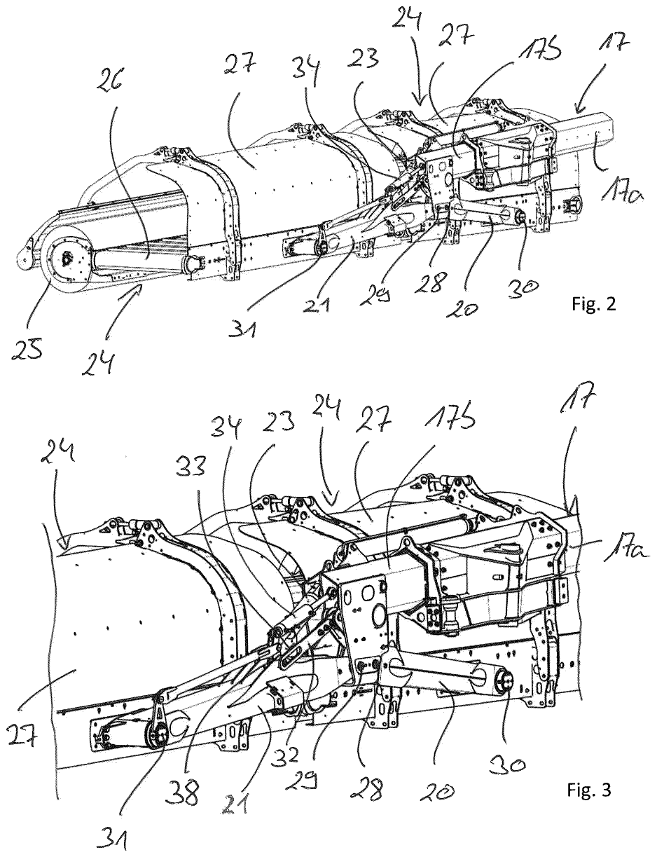

FIG. 2 shows a detail from FIG. 1;

FIG. 3 shows a detail from FIG. 2;

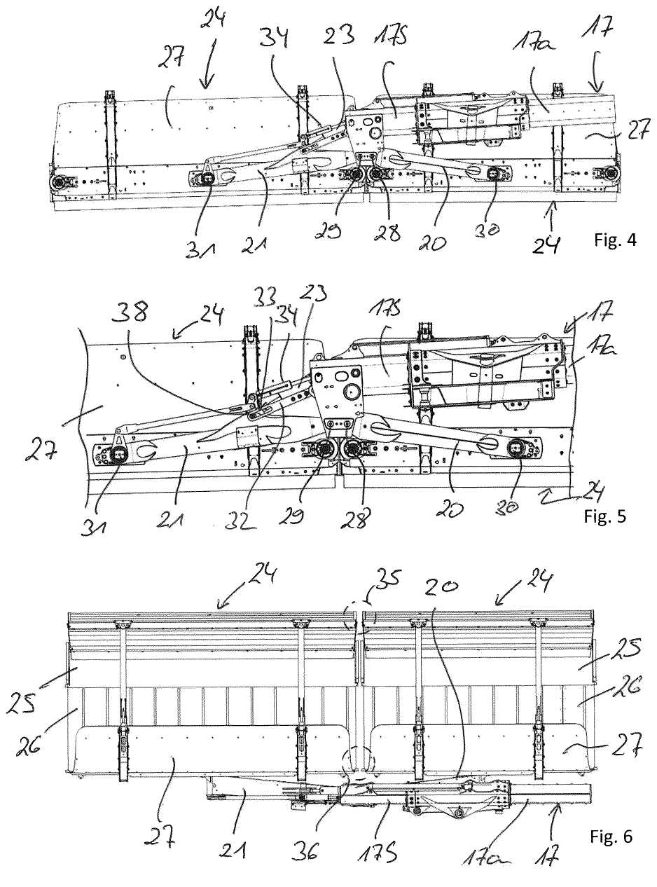

FIG. 4 shows the detail from FIG. 2 from behind;

FIG. 5 shows a detail from FIG. 2;

FIG. 6 shows the detail from FIG. 2 from above;

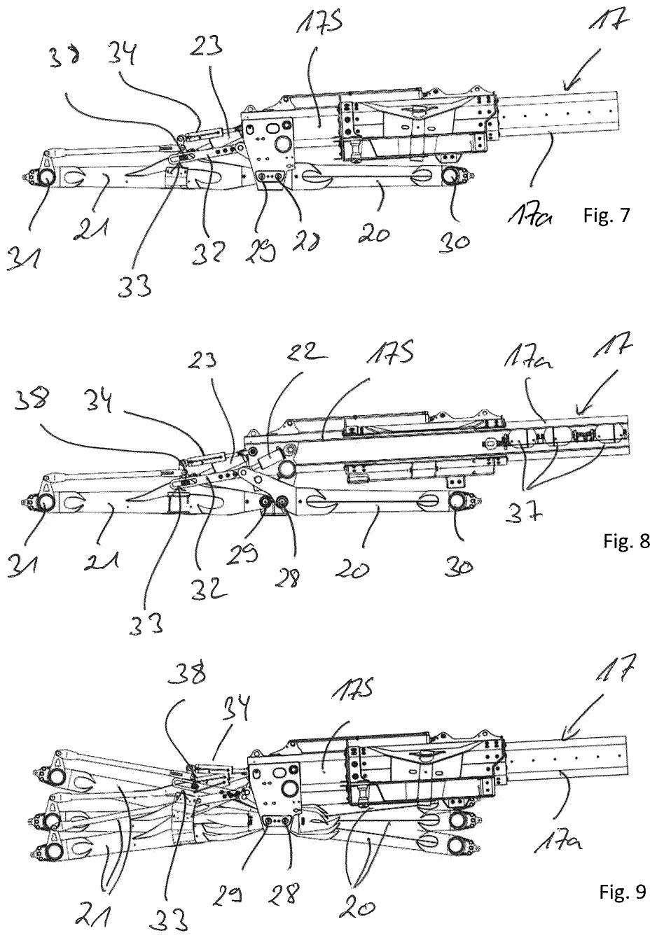

FIG. 7 shows a detail from FIG. 5;

FIG. 8 shows a cross section through the detail from FIG. 7;

FIG. 9 shows the detail from FIG. 7 in different states.

The present invention relates to an agricultural harvester 10. The agricultural harvester 10 is, in particular, a forage harvester that can be coupled to a towing vehicle in order to be pulled by the towing vehicle.

FIG. 1 shows an agricultural harvester 10 according to the invention in a working position. The agricultural harvester 10 has a frame or framework 11 with a longitudinal member 12, and with a drawbar 13 attached to the longitudinal member 12 of the frame or framework 11. The agricultural harvester 10 can be coupled to a towing vehicle via the drawbar 13, or via a coupling bracket 14 engaging the drawbar 13 in an articulated manner, in order to be pulled along by the towing vehicle.

A chassis 15 with wheels 16 engages on the frame or framework 11 of the agricultural harvester 10, wherein, during movement of the agricultural harvester 10, the latter is supported on a ground surface via the wheels 16 and thus via the chassis 15.

The agricultural harvester 10 has two main booms 17. To each side of the frame 11 or of the longitudinal member 12, a main boom 17 engages the frame or framework 11, specifically in such a way that, in order to transfer the harvester 10 between the working position shown in FIG. 1 and a transport position (not shown), the respective main boom 17 is movable relative to the frame or framework 11.

To provide this mobility of the respective main boom 17 relative to the frame or framework 11, two main cylinders 18, 19 each act on the frame or framework 11 and the respective main boom 17, in order to move the respective main boom 17, together with the assemblies engaging on the respective main boom 17, relative to the frame or framework 11.

The agricultural harvester 10 also has relief booms 20, 21. Two relief booms 20, 21 engage on each of the two main booms 17, namely a first, inner or inward relief boom 20 relative to the longitudinal central axis or the longitudinal member 12 of the harvester 10, and a second, outer or outward relief boom 21 relative to the longitudinal member 12 and the longitudinal central axis of the harvester 10.

Each of the relief booms 20, 21 is individually movable relative to the respective main boom 17 via an individual relief cylinder 22, 23 in order to provide a relief function individual to the relief boom. Thus, a first relief cylinder 22 engages the first respective relief boom 20 and a second relief cylinder 23 engages the respective second relief boom 21, wherein these relief cylinders 22, 23 also engage the respective main boom 17.

Thus, each relief boom 20, 21 of the agricultural harvester 10 can be individually moved relative to the respective main boom 17 via its respective relief cylinder 22, 23 in order to provide the relief function individual to the relief boom.

The agricultural harvester 10 also has working units 24, wherein one working unit 24 engages on each relief boom 20, 21. In the exemplary embodiment shown, in which the agricultural harvester 10 is designed as a merger and thus a pickup belt rake, each working unit 24 comprises a pickup 25 and a belt conveyor segment 26. For some of the working units 24 shown in the figures, the respective pickup 25 and the respective belt conveyor segment 26 are covered by a covering 27.

Each of the working units 24 of the agricultural harvester 10 engages the respective relief boom 20, 21 in such a way that the respective working unit 24 is movable relative to the respective relief boom 20, 21 in order to provide a ground-following function.

In the exemplary embodiment shown, each of the main booms 17 is formed as a telescopic boom with a first telescopic boom part 17a engaging on the frame or framework 11 and with a second telescopic boom part 17b which can be telescoped relative to the first telescopic boom part 17a. This is preferred in order to provide a large working width in the working position and to reduce the dimensions of the agricultural harvester 10 in the transport position.

Two relief booms 20, 21 engage on each of the second telescopic boom parts 17b of the two main booms 17. To provide the relief function in a manner individual to each relief boom, the respective relief cylinder 22, 23 engages with a first portion on each of the two respective relief cylinders 20, 21, wherein each of the relief cylinders 22, 23 engages with a second portion on the respective second telescopic boom part 17b of the respective main boom 17.

In the preferred exemplary embodiment shown, the respective first, inner or inward relief boom 20, with respect to the longitudinal central axis or to the longitudinal member 12 of the frame or framework 11 in the working position, is movable relative to the main boom 17 about an axle 28 lying externally on same, namely, in the exemplary embodiment shown, pivotably relative to the second telescopic boom part 17b. The outer or outward relief boom 21, with respect to the longitudinal central axis or to the longitudinal member 12 of the frame or framework 11, is movable, namely pivotable, relative to the respective main boom 17 about an inner axle 29. In the working position of the harvester, these axles 28, 29 run in the longitudinal direction or parallel to the longitudinal central axis of the harvester 10. For the movement of the relief booms 20, 21 about the axles 28, 29 relative to the main boom 17, the respective relief cylinders 22, 23 engage the main boom 17 and the relief booms 20, 21.

The two axles 28 and 29 could also be replaced by a common axle.

In this case, in the exemplary embodiment shown, the relief cylinder 22 engaging on the inner or inward relief boom 20 is designed as a pressing cylinder, and the relief cylinder 23 engaging on the outer or outward relief boom 21 is designed as a pulling cylinder.

The working units 24 engaging on the relief booms 20, 21 are movable, namely pivotable, relative to the respective relief boom 20, 21. Thus, the working unit 24 engaging on the inner or inward relief boom 20 is movable, namely pivotable, relative to the relief boom 20 about an axle 30 lying preferably centrally on the inward relief boom 20, and the working unit 24 engaging on the outer or outward relief boom 21 is movable, namely pivotable, relative to the relief boom 21 about an axle 31 lying preferably centrally on the outward relief boom 21. These axles 30, 31, about which the working units 24 are pivotable relative to the relief booms 20, 21, run in turn in the working direction of the harvester in the longitudinal direction, thus parallel to the axles 28, 29.

From the above statements, it follows that each relief boom 20, 21, together with the working unit 24 engaging on the respective relief boom 20, 21, is movable relative to the respective main boom 17 via the respective relief cylinder 22, 23 in order to provide a relief function, namely the ground relief function.

Furthermore, each working unit 24 is movable relative to the respective relief boom 20, 21 in order to provide a ground-following function. This means that, in the case of large working widths, the relief function and ground-following function can be provided in a targeted manner, namely individually, for each working unit 24.

Furthermore, during the transfer of the agricultural harvester 10 between the working position and the transport position, each relief boom 20, 21, together with its respective working unit 24, is movable relative to the longitudinal member 12 of the framework or frame 11 via the respective main boom 17 and the main cylinders 18, 19.

The two respective relief booms 20, 21, which are arranged to the same side of the framework or frame 11 of the agricultural harvester 10 and engage on the respective main boom 17, are coupled in order to limit the mobility of the two respective relief booms 20, 21 relative to each other in the working position of the agricultural harvester 10.

Thus, FIG. 3 and FIG. 5 in particular show a coupling rod 32 which at a first end engages in an articulated manner on one of the two respective relief booms 20, 21, namely in the illustrated exemplary embodiment on the inner or inward relief boom 20, wherein, at an opposite second end of the coupling rod 32, an oblong hole 33 is formed in which the other of the two respective relief booms, in the illustrated exemplary embodiment the respective outer or outward relief boom 21, is guided with a projection 38. The oblong hole 33 limits the mobility of the two respective relief booms 20, 21 relative to each other in the working position of the agricultural harvester 10.

In the working position of the agricultural harvester 10, a locking cylinder 34, which is active in the transport position and preferably also in a headland position of the agricultural harvester 10, is inactive. An inactive locking cylinder 34 allows the relative movement of the working units 24 about their central axes. By contrast, in the transport position and, if necessary, the headland position of the agricultural harvester 10, the locking cylinder 34 prevents a swinging movement of the working units 24 about their central axes. The locking cylinder 34 is preferably also designed to bring the working units 24 into, and fix them in, an optimal position or orientation defined for folding or for moving them to the transport position and/or to a headland position. FIG. 9 shows the relief booms 20, 21 in different positions relative to each other.

The working units 24 engaging on the respective relief booms 20, 21 of the agricultural harvester 10 are also coupled. In this way, the mobility of the two respective working units 24 relative to each other, which are arranged to the same side of the frame or framework 11 of the agricultural harvester 10 on the respective relief booms 20, 21, is limited in the working position of the agricultural harvester 10. Corresponding coupling devices are not shown in the figures. However, the same may be formed or arranged between the juxtaposed working units 24 both in the front region 35 shown in FIG. 6 and in the rear region 36 shown in FIG. 6, between working units 24 positioned to the same side of the framework or frame 11 of the agricultural harvester 10.

Therefore, the agricultural harvester 10 shown in the illustrated exemplary embodiment has two main booms 17, which are preferably designed as telescopic booms, wherein two relief booms 20, 21 each with a working unit 24 engage on each main boom 17. There are therefore two main booms 17, four relief booms 20, 21 and four working units 24. To each side of the frame or framework, there are one main boom 17, two relief booms 20, 21 and two working units 24. Each working unit 24 is pivotable relative to the respective relief boom 20, 21 on which it engages. Furthermore, each relief boom 20, 21 is pivotable relative to the respective main boom 17 on which it engages. When the main booms 17 are telescopic booms, the relief booms 20, 21 engage on the movable telescopic boom part 17b.

Even with large working widths of more than 10 meters, both the ground relief function and the ground-following function can be individually provided in a targeted manner for the individual working units 24. The relief cylinders 32, 33 and the locking cylinder 34 can be hydraulically actuated. According to FIG. 8, hydraulic accumulators 37 for these cylinders 32, 33, 34 are arranged within the respective main boom 17. The two telescopic boom parts 17a, 17b are preferably provided by hexagonal profiles.

The individual relief function and ground-following function for each of the working units 24 is fast and agile. Each working unit 24 can be operated in its desired position by a corresponding pressure control of its relief cylinder 20, 21, providing a desired ground relief always in the optimal relief range. The working units 24 act independently of each other and can be relieved individually. It is only in boundary regions that the mobility of the relief booms 20, 21 relative to each other and the mobility of the working units 24 relative to each other are limited by a coupling, so as to be able to maintain the desired function of the harvester 10 and to avoid critical conditions, such as collisions of the individual working units 24.

The agricultural harvester 10 is preferably a forage harvester such as a merger or pickup belt rake, wherein, in the case of a merger, a pickup 25 and a belt conveyor segment 26 act, as working unit 24, on each of the relief booms 20, 21. The agricultural harvester 10 can be designed as a tedder or mower.

### LIST OF REFERENCE SIGNS

10 harvester
11 framework/frame
12 longitudinal member
13 drawbar
14 coupling bracket
15 chassis
16 wheel
17 main boom
17a telescopic boom part
17b telescopic boom part
18 main cylinder
19 main cylinder
20 relief boom
21 relief boom
22 relief cylinder
23 relief cylinder
24 working unit
25 pickup
26 belt conveyor segment
27 covering
28 axle
29 axle
30 axle
31 axle
32 coupling lever
33 oblong hole
34 locking cylinder
35 region
36 region
37 hydraulic accumulator
38 projection

1. An agricultural harvester (10), with a frame or a framework (11) on which a chassis (15) engages, with main booms (17), wherein on both sides of the frame or framework (11) a main boom (17) engages on the frame or framework (11) in such a way that, in order to transfer the harvester (10) between a working position and a transport position, the respective main boom (17) is movable relative to the frame or framework (11), with relief booms (20, 21), wherein two relief booms (20, 21) in each case engage on each of the two main booms (17), which relief booms are individually movable relative to the respective main boom (17) via relief cylinders (22, 23) in order to provide a relief function, and with working units (24), wherein in each case at least one working unit (24) engages on each of the relief booms (20, 21) and is movable relative to the respective relief boom (20, 21) in order to provide a ground-following function.

2. The agricultural harvester (10) according to claim 1, characterized in that the respective main boom (17) is designed as a telescopic boom with a first telescopic boom part (17a) engaging on the frame or framework (11) and with a second telescopic boom part (17b) which can be telescoped relative to the first telescopic boom part (17a).

3. The agricultural harvester (10) according to claim 2, characterized in that two relief booms (20, 21) engage on the respective second telescopic boom part (17b) and, in order to provide the relief function individually for each of the two respective relief booms (20, 21), one relief cylinder (22, 23) engages with a first portion and each of the relief cylinders (22, 23) with a second portion on the respective second telescopic boom part (17b).

4. The agricultural harvester (10) according to claim 1, characterized in that a first of the two respective relief booms is a relief boom (20) lying inward relative to a longitudinal central axis of the frame or framework (11) in the working position, and a second of the two respective relief booms is a relief boom (21) lying outward relative to the longitudinal central axis of the frame or framework (11) in the working position, wherein the inward relief boom (20) is movable, about an axle (28) lying externally on same, and the outward relief boom (21) is movable, about an axle (29) lying internally on same, relative to the respective main boom (17) via the respective relief cylinder (22, 23).

5. The agricultural harvester (10) according to claim 4, characterized in that the axles (28, 29), about which the relief booms (20, 21) are pivotable relative to the respective main boom (17), run in the longitudinal direction of the harvester (10) in the working position thereof.

6. The agricultural harvester (10) according to claim 4, characterized in that the working unit (24) engaging on the inward relief boom (20) is movable relative to the inward relief boom (20) about an axle (30) lying on the inward relief boom (20), and the working unit (24) engaging on the outward relief boom (21) is movable relative to the outward relief boom (21) about an axle (31) lying on the outward relief boom (21).

7. The agricultural harvester (10) according to claim 6, characterized in that the axles (30, 31) about which the working units (24) are pivotable relative to the relief booms (20, 21) run in the longitudinal direction of the harvester (10) in the working position thereof.

8. The agricultural harvester (10) according to claim 4, characterized in that a relief cylinder (22) engaging on the first respective relief boom (20) is designed as a pressing cylinder, and a relief cylinder (23) engaging on the second respective relief boom (21) is designed as a pulling cylinder.

9. The agricultural harvester (10) according to claim 1, characterized in that the two respective relief booms (20, 21) are coupled in order to limit the mobility of the two respective relief booms (20, 21) relative to each other in the working position of the harvester (10).

10. The agricultural harvester (10) according to claim 9, characterized in that a respective coupling rod (32) engages at a first end in an articulated manner on one of the two respective relief booms (20), and in that, at an opposite second end of the respective coupling rod, an oblong hole (33) is formed in which the other of the two respective relief booms (21) is guided with a projection (38), wherein the oblong hole (33) limits the mobility of the two respective relief booms (20, 21) relative to each other in the working position of the harvester (10).

11. The agricultural harvester (10) according to claim 1, characterized by a locking cylinder (34) which, in the transport position and/or a headland position of the harvester (10), suppresses a swinging movement of the working units (24) relative to the respective relief boom (20, 21) and/or moves the working units (24) into, and fixes them in, a position or orientation defined for the movement to the transport position and/or to a headland position.

12. The agricultural harvester (10) according to claim 1, characterized in that the working units (24) engaging on the two respective relief booms (20, 21) are coupled in order to limit the mobility of the two respective working units (24) relative to each other in the working position of the harvester (10).

13. The agricultural harvester (10) according to claim 1, characterized in that the harvester is a forage harvester.

14. The agricultural harvester (10) according to claim 13, characterized in that the forage harvester is a merger or pickup belt rake, wherein a pickup (25) and a belt conveyor segment (26) engage, as working unit (24), on each of the relief booms (20, 21).
